(19) United States
(12) Patent Application Publication
(10) Pub. No.: US 2025/0252301 A1
(43) Pub. Date: Aug. 7, 2025

(54) FINE-TUNING A NEURAL NETWORK MODEL USING A WEIGHT-DECOMPOSED LOW-RANK ADAPTATION

(71) Applicant: NVIDIA Corporation, Santa Clara, CA (US)

(72) Inventors: Min-Hung Chen, Zhubei City (TW); Shih-Yang Liu, New Taipei City (TW); Chien-Yi Wang, New Taipei City (TW); Hongxu Yin, San Jose, CA (US); Pavlo Molchanov, Mountain View, CA (US); Yu-Chiang Wang, Taipei (TW)

(21) Appl. No.: 18/807,801

(22) Filed: Aug. 16, 2024

Related U.S. Application Data
(60) Provisional application No. 63/550,269, filed on Feb. 6, 2024.

(51) Int. Cl. G06N 3/08

(52) U.S. Cl. CPC G06N 3/08

(57) ABSTRACT

Embodiments of the present disclosure relate to fine-tuning a neural network model using a weight-decomposed low-rank adaptation (DoRA). DoRA reduces the number of parameters that are fine-tuned, thereby reducing memory and the time needed to fine-tune the parameters. the Pre-trained weights are decomposed into two components, magnitude and direction, which are separately fine-tuned. The magnitude components are fine-tuned while the direction components remain unchanged (frozen). Then low-rank adaptation (LoRA) is used to fine-tune the direction components, efficiently minimizing the number of trainable parameters. Compared with using LoRA to fine-tune the weights directly, using DoRA exhibits a closer resemblance to full fine-tuning's learning behavior and improves upon LoRA in commonsense reasoning and visual instruction tuning tasks. By employing DoRA, both the learning capacity and training stability of LoRA is enhanced. The fine-tuned decomposed magnitude and direction components may be merged into the pre-trained weights to avoid any additional inference overhead.

### CLAIM OF PRIORITY

This application claims the benefit of U.S. Provisional Application No. 63/550,269 titled “Weight-Decomposed Low-Rank Adaptation,” filed Feb. 6, 2024, the entire contents of which is incorporated herein by reference.

### BACKGROUND

Fine-tuning a neural network model may improve accuracy and better tailor the neural network model for a specific task. However, fine-tuning is computationally intensive. Compared with full fine-tuning, conventional techniques for parameter-efficient fine-tuning the number of parameters that are fine-tuned is reduced, reducing memory and the time needed to fine-tune the parameters. Although improvements have been made, further improvement in learning capacity and training stability are desired. There is a need for addressing these issues and/or other issues associated with the prior art.

### SUMMARY

Embodiments of the present disclosure relate to fine-tuning a neural network model using a weight-decomposed low-rank adaptation (DoRA). DoRA reduces the number of parameters that are fine-tuned, thereby reducing memory and the time needed to fine-tune the parameters. Pre-trained weights are decomposed into two components, magnitude and direction, which are separately fine-tuned. The magnitude components are fine-tuned while the direction components remain unchanged (frozen). Then low-rank adaptation (LoRA) is used to fine-tune the direction components, efficiently minimizing the number of trainable parameters. Compared with using LoRA to fine-tune the weights directly, using DoRA exhibits a closer resemblance to full fine-tuning's learning behavior and improves upon LoRA in commonsense reasoning and visual instruction tuning tasks. By employing DoRA, both the learning capacity and training stability of LoRA is enhanced. The fine-tuned decomposed magnitude and direction components may be merged into the pre-trained weights to avoid any additional inference overhead.

Systems and methods are disclosed for a parameter-efficient fine-tuning technique that directionally adjusts the pre-trained parameters in a manner which is more closely aligned with adjustments during full fine-tuning compared with conventional techniques. In contrast to conventional techniques, such as those described above, DoRA does not increase latency and improves accuracy, approaching the accuracy of full fine-tuning.

In an embodiment, the method for fine-tuning parameters of a neural network model includes decomposing pre-trained parameters for the neural network model into magnitude components and direction components and applying, by the neural network model, the pre-trained parameters to training inputs to generate predicted outputs. The magnitude components and direction components are each updated using gradient-based optimization to minimize differences between the predicted outputs and training outputs associated with the training inputs, parameter updates are computed based on the updated magnitude components and the updated direction components, and the parameter updates are combined with the pre-trained parameters to produce fine-tuned parameters.

### BRIEF DESCRIPTION OF THE DRAWINGS

The present systems and methods for fine-tuning a neural network model using a weight-decomposed low-rank adaptation are described in detail below with reference to the attached drawing figures, wherein:

FIG. 1A illustrates a block diagram of an example weight-decomposed fine-tuning system suitable for use in implementing some embodiments of the present disclosure.

FIG. 1B illustrates vector magnitude decomposition, in accordance with the prior art.

FIG. 2A illustrates a block diagram of an example parameter decomposition unit shown in FIG. 1A suitable for use in implementing some embodiments of the present disclosure.

FIG. 2B illustrates a graph of average accuracy of LoRA and DoRA for varying ranks, in accordance with an embodiment.

FIG. 3A illustrates a flowchart of a method for fine-tuning parameters of a neural network model, in accordance with an embodiment.

FIG. 3B illustrates images generated by a neural network model trained using LoRA and DoRA, in accordance with an embodiment.

FIG. 4 is a conceptual diagram of a processing system implemented using a PPU, suitable for use in implementing some embodiments of the present disclosure.

FIG. 5A illustrates an exemplary system in which the various architecture and/or functionality of the various previous embodiments may be implemented.

FIG. 5B illustrates components of an exemplary system that can be used to train and utilize machine learning, in at least one embodiment.

FIG. 6 illustrates an exemplary streaming system suitable for use in implementing some embodiments of the present disclosure.

### DETAILED DESCRIPTION

Systems and methods are disclosed related to fine-tuning a neural network model using a weight-decomposed low-rank adaptation. The pre-trained weights may result from training a large language model for a general task such as natural (NLP) processing or multi-modal tasks, such as vision-language tasks. In an embodiment, the fine-tuning tailors the neural network model for performing a more specific task.

Embodiments of the present disclosure relate to fine-tuning a neural network model using weight-decomposed low-rank adaptation (DoRA). DoRA reduces the number of parameters that are fine-tuned, thereby reducing memory and the time needed to fine-tune the parameters. Pre-trained weights are decomposed into two components, magnitude and direction, which are separately fine-tuned. The magnitude components are fine-tuned while the direction components remain unchanged (frozen). Then low-rank adaptation (LoRA) is used to fine-tune the direction components, efficiently minimizing the number of trainable parameters. Compared with using LoRA to fine-tune the weights directly, using DoRA exhibits a closer resemblance to full fine-tuning's learning behavior and improves upon LoRA in commonsense reasoning and visual instruction tuning tasks. By employing DoRA to separately fine-tune the magnitude and direction components of the decomposed weights, both the learning capacity and training stability is enhanced compared with using LoRA. In an embodiment, during a first fine-tuning phase the magnitude components are fine-tuned while the direction components remain unchanged (frozen). During a second fine-tuning phase both the magnitude and direction components are fine-tuned. In an embodiment, during the second fine-tuning phase the magnitude components are frozen and the direction components are fine-tuned. Allowing the magnitude and direction components to be separately updated using gradient-based optimization enables the components to be updated differently and at different times during the fine-tuning process, more closely matching a learning pattern of full fine-tuning for a variety of tasks. In contrast, LoRA updates the weights directly and cannot achieve a learning pattern that is similar to full fine-tuning. The fine-tuned decomposed magnitude and direction components may be merged into the pre-trained weights to avoid any additional inference overhead.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

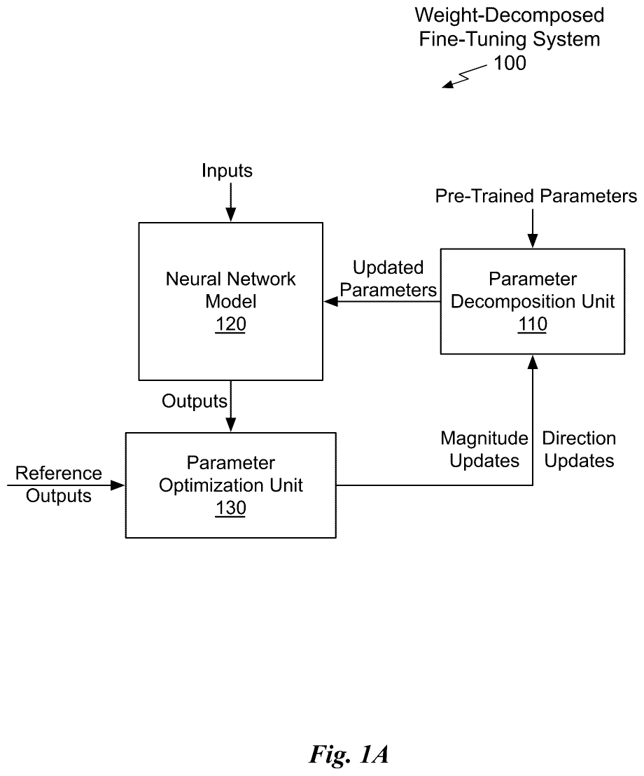

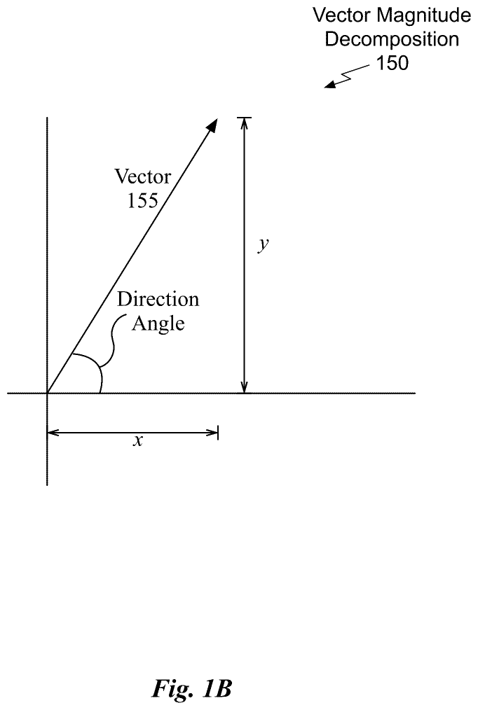

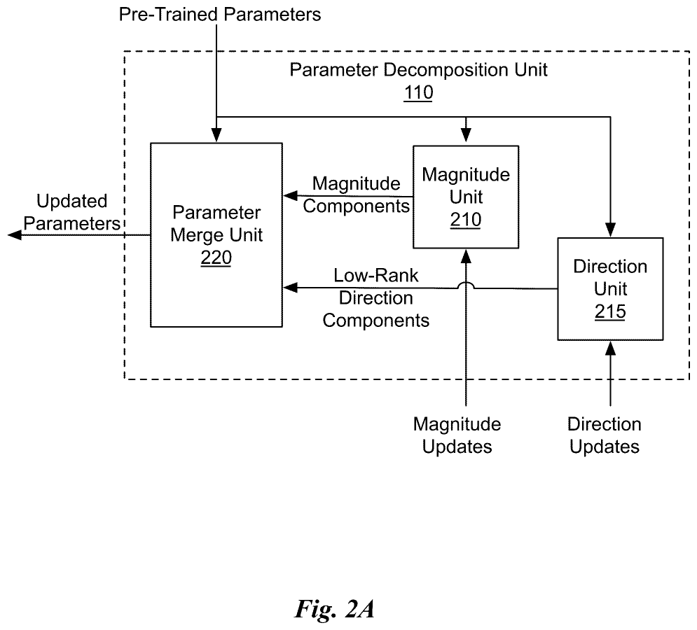

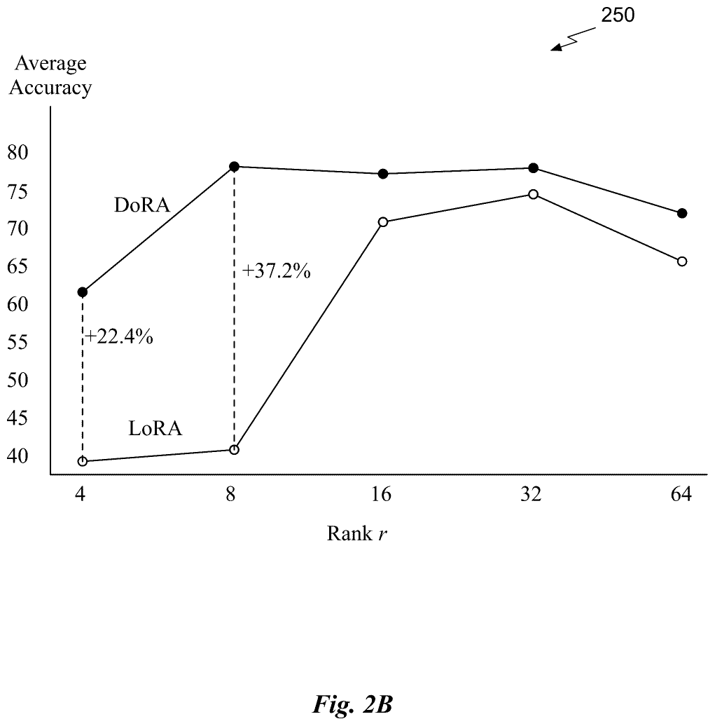

FIG. 1A illustrates a block diagram of an example weight-decomposed fine-tuning system 100 suitable for use in implementing some embodiments of the present disclosure. A parameter decomposition unit 110 decomposes the pre-trained parameters into magnitude and direction components and provides the updated parameters to a neural network model 120. A detailed description of the parameter decomposition unit 110 is provided in conjunction with FIG. 2A. During fine-tuning, a parameter optimization unit 130 evaluates a loss function and computes updates for the magnitude components and the direction components to reduce differences between reference outputs and predicted outputs generated by the neural network model 120 by applying the parameters to inputs.

It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the weight-decomposed fine-tuning system 100 is within the scope and spirit of embodiments of the present disclosure.

The magnitude components and direction components are fine-tuned using training data (inputs and associated reference outputs). Importantly, the magnitude components are adjusted separately from the direction components according to a loss function. Initially for the fine-tuning, the updated parameters are equivalent to the pre-trained parameters W₀. The neural network model 120 applies the pre-trained parameters to the inputs to predict outputs. The parameter optimization unit 130 evaluates the loss function and computes updates for the magnitude components to reduce differences between the reference outputs and the predicted outputs. In an embodiment, the direction components are frozen during a first phase and are not updated. In another embodiment, both the magnitude components and the direction components are updated during the first phase. The parameter decomposition unit 110 updates the magnitude components to provide the updated parameters to the neural network model 120 for another iteration of fine-tuning during a second phase.

During the second phase, the neural network model 120 applies the updated parameters to the inputs to predict outputs. The parameter optimization unit 130 evaluates the loss function and computes updates for the magnitude components and the direction components to reduce differences between the reference outputs and the predicted outputs. The parameter decomposition unit 110 updates the magnitude components and the direction components to provide the updated parameters to the neural network model 120 for additional fine-tuning or the fine-tuning is complete.

In an embodiment, the parameter optimization unit 130 computes the updates using a gradient-based optimization algorithm (such as gradient descent or deterministic, stochastic, or heuristic techniques). In an embodiment, training iterations are continued until a criterion is met (convergence, loss is within a threshold, fixed number of iterations, training data is exhausted, etc.). When the fine-tuning training is complete, the updated parameters are combined with the pre-trained parameters for inference. In an embodiment, the updated parameters replace the pre-trained parameters.

In an embodiment, the direction components are fine-tuned using LoRA. LoRA is described by Hu, E. J., et. al in “LoRA: Low-rank adaptation of large language models.” In International Conference on Learning Representations, 2022 which is incorporated herein by reference. LoRA is a parameter-efficient fine-tuning (PEFT) method that approximates changes in the weights as a product of two low-rank matrices A and B and updates A and B incrementally. The low-rank matrices, A and B are initialized from a normal distribution and zero, respectively. This initialization facilitates the initial fine-tuning with pre-trained weights. During fine-tuning, backpropagation is performed to update the A and B low-rank matrices, effectively reducing memory and time requirements. For instance, while traditional optimizers store three times the number of model parameters, LoRA stores only (number of parameters of the model+ (A+B)*3), where (A+B)*3 surpasses twice the number of model parameters, thereby mitigating memory and time overhead. The main advantage of LoRA is avoiding additional inference costs. However, there is still a performance gap between full fine-tuning and LoRA, which is often attributed to the limited number of trainable parameters.

For a pre-trained weight matrix W₀∈ [symbol] , LoRA models the weight update ΔW∈ [symbol] as BA, with r<<min (d,k). Consequently, the fine-tuned weight W′ can be represented as:

$${W}^{′} = {W}_{0} + Δ W = {W}_{0} + \underline{BA} \qquad Eq . ( 1 )$$

where W₀ remains static during the fine-tuning process, and the underlined parameters are being updated. Additionally, based on Eq. (1), the learned ΔW can be combined or merged with the pre-trained weights W₀ to obtain W′ and the number of fine-tuned weights remains the same as before fine-tuning. In an embodiment, merging comprises summing the μW with W₀ for the first iteration and subsequently summing the learned μW with W′.

LoRA can be considered a general approximation of full fine-tuning. By gradually increasing the rank r of LoRA to align with the rank of pre-trained weights, LoRA can attain a level of expressiveness akin to that of full fine-tuning (FT). Consequently, many previous studies have attributed the discrepancy in accuracy between LoRA and FT primarily to the limited number of trainable parameters, often without further analysis. An innovative weight decomposition analysis restructures the weight matrix into the two separate components, magnitude and direction, to reveal the inherent differences in LoRA and FT learning patterns.

The weight decomposition analysis reveals that LoRA exhibits a consistent positive slope trend across all the intermediate steps, signifying a proportional relationship between the changes in direction and magnitude. In contrast, the FT displays a more varied learning pattern with a relatively negative slope. This distinction between FT and LoRA likely mirrors their respective learning capability. While LoRA tends to either increase or decrease the magnitude and direction updates proportionally, it lacks the nuanced capability for more subtle adjustments. Specifically, LoRA does not show proficiency in executing slight directional changes alongside more significant magnitude alterations, or vice versa, a feature more characteristic of the FT method. This limitation of LoRA might stem from the challenge of concurrent learning both magnitude and directional adaptation, which could be overly complex for LoRA. Consequently, a goal of DoRA is to enable a learning pattern that more closely resembling that of FT, and therefore improves the learning capacity compared with LoRA.

FIG. 1B illustrates vector magnitude decomposition 150, in accordance with the prior art. The pre-trained weight matrix comprises columns of a vectors and any vector 155 can be represented as a product of a magnitude and direction. The magnitude is a scalar value defining a length, ∥v∥=\sqrt{x²+y²}. The direction is a unit vector defining an angle or, more generally, an orientation in space. In an embodiment, the pre-trained parameters (weights W∈ [symbol] ) are decomposed into magnitude components m and direction components, matrix V, such that

$$W = m \frac{V}{{‖ V ‖}_{c}} = {‖ W ‖}_{c} \frac{W}{{‖ W ‖}_{c}} .$$

The magnitude vector m∈ [symbol] and V∈ [symbol] is the directional matrix, with ∥·∥_{c} being the vector-wise norm of a matrix across each column. Therefore, each vector column or direction vector is associated with one magnitude scalar value.

FIG. 2A illustrates a block diagram of an example parameter decomposition unit 110 shown in FIG. 1A suitable for use in implementing some embodiments of the present disclosure. The magnitude unit 210 computes and initializes the magnitude vectors from the pre-trained parameters, m=∥W₀∥_{c}. The direction unit 215 computes and initializes the direction matrices (low-rank direction components) from the pre-trained parameters, V=W₀. The updated parameters are initialized as W′=W₀. Note, the neural network model 120 cannot apply the decomposed weights to the inputs, so the magnitude and directional components are converted to weights (via merging) for use by the neural network model 120 to generate outputs. In an embodiment, the parameter merge unit 220 computes separate parameter updates for the magnitude and directional components and then the updated magnitude and directional components are used to compute the updated parameters (fine-tuned parameters). The parameter merge unit 220 computes the updated parameters W′ that are applied to the training data (inputs) by the neural network model 120 to generate the outputs during training. When fine-tuning is finished, the updated parameters W′ are the fine-tuned weights that can be used when the neural network model 120 is deployed for inference.

Because the direction component is large in terms of parameter numbers, in an embodiment, the direction component is further decomposed using LoRA for efficient fine-tuning. Limiting LoRA to concentrate exclusively on directional adaptation while also allowing the magnitude component to be tunable simplifies the task compared to the conventional approach, where LoRA is required to learn adjustments in both magnitude and direction. Additionally, the process of optimizing direction updates is made more stable through weight decomposition. In an embodiment, during a first phase of fine-tuning V is frozen and m is updated. During a second phase of fine-tuning, the direction component is indirectly updated through LoRA.

Instead of updating the direction components (direction matrices) themselves, when LoRA is used the direction components are represented as a base direction and two low-rank (small) weight matrices A∈ [symbol] and B∈ [symbol] . DoRA can be formulated similar to Eq. (1) as

$${W}^{′} = \underline{m} \frac{V + Δ V}{{‖ V + Δ V ‖}_{c}} = \underline{m} \frac{{W}_{0} + \underline{BA}}{{‖ {W}_{0} + \underline{BA} ‖}_{c}} \qquad Eq . ( 2 )$$

where ΔV is the incremental direction update learned by multiplying two low-rank matrices B and A, and the underlined parameters denote the trainable parameters (m, B, and A).

In an embodiment, ∥V+ΔV∥_{c} is treated as a constant and no gradient is computed by the parameter optimization unit 130 via backpropagation for updating ∥V+ΔV∥_{c}. However, ∥V+ΔV∥_{c} will dynamically reflect the updates of ΔV caused by fine-tuning B and A. This approach reduces the gradient graph memory consumption drastically without a noticeable difference in accuracy. The gradient w.r.t. m remains unchanged, and ¤_{V}, [symbol] is redefined as:

$${∇}_{V} , ℒ = \frac{m}{C} {∇}_{W} , ℒ where C = {‖ {V}^{′} ‖}_{c} \qquad Eq . ( 3 )$$

The magnitude components and direction components are trained (fine-tuned) using training data (inputs and associated reference outputs). Importantly, the magnitude components are adjusted separately from the directional components according to a loss function. In an embodiment, the pre-trained parameters may be quantized before they are input to the weight-decomposed fine-tuning 100. Quantizing reduces the amount of memory needed to store the pre-trained parameters and the number of bits that are processed. In an embodiment, DoRA significantly outperforms LoRA when pre-trained parameters are quantized. In an embodiment, the pre-trained parameters are quantized to 4-bits. Furthermore, DoRA also outperforms full fine-tuning when the pre-trained parameters are quantized. Using quantized parameters, DoRA not only significantly surpasses LoRA with an accuracy (exact match score) improvement of 0.19, but it also slightly outperforms full fine-tuning by 0.05, while using considerably less memory. Using quantization, DoRA effectively combines the parameter efficiency of LoRA with the more granular optimization of full finetuning. These initial findings suggest that DoRA holds considerable promise and could substantially lower the memory requirements for fine-tuning large language models.

The neural network model 120 may be fine-tuned for a variety of tasks, such as natural language processing (NLP), multi-modal processing, vision-language, commonsense reasoning, visual instruction, and image/video-text understanding. DoRA demonstrates the ability to make only substantial directional adjustments with relatively minimal changes in magnitude or the reverse while showing learning patterns closer to full fine-tuning signifies DoRA's superior learning capacity compared with LoRA.

FIG. 2B illustrates a graph 250 of average accuracy of LoRA and DoRA for varying ranks, in accordance with an embodiment. DoRA consistently surpasses LoRA across all rank configurations. Notably, the performance gap widens for ranks below 8, where LoRA's average accuracies drop to 40.74% for r=8 and 39.49% for r=4. In contrast, DoRA retains a notable accuracy of 77.96% for r=8 and 61.89% for r=4, demonstrating its resilience and consistently superior performance over LoRA regardless of the rank setting. Furthermore, DoRA is more robust to changes in rank compared with LoRA, with DoRA achieving good accuracy even for a small rank.

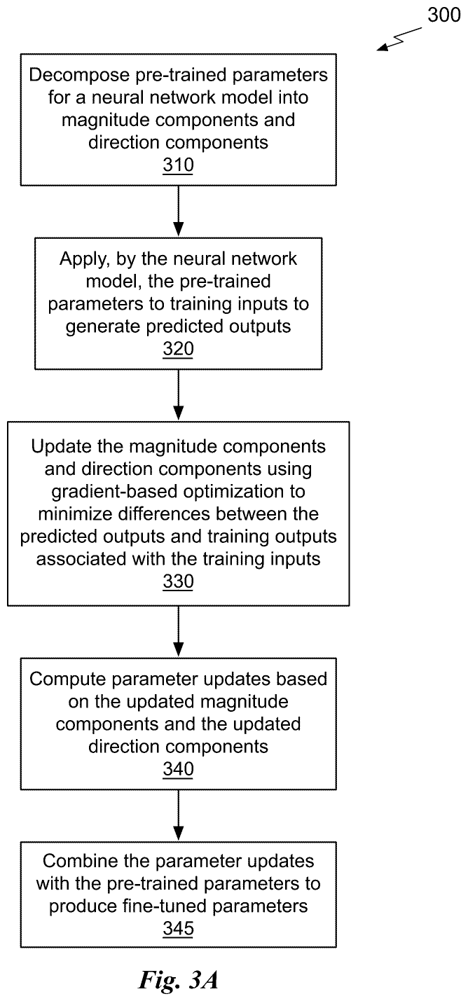

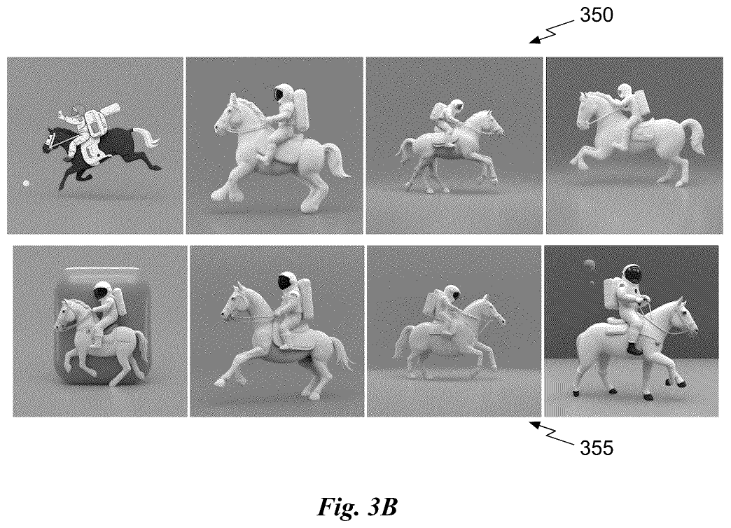

FIG. 3A illustrates a flowchart of a method 300 for fine-tuning parameters of a neural network model, in accordance with an embodiment. Each block of method 300, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the weight-decomposed fine-tuning system 100 of FIG. 1A. However, this method may additionally or alternatively be executed by any one system, or any combination of systems, including, but not limited to, those described herein. Furthermore, persons of ordinary skill in the art will understand that any system that performs method 300 is within the scope and spirit of embodiments of the present disclosure.

At step 310, pre-trained parameters for the neural network model are decomposed into magnitude components and direction components. In an embodiment, the magnitude components each comprise a scalar value defining a length. In an embodiment, the direction components each comprise a base vector and two low-rank matrices.

At step 320, the neural network model applies the pre-trained parameters to training inputs to generate predicted outputs. In an embodiment, the neural network model performs a task in a domain including at least one of language, image, and video.

At step 330, updating the magnitude components and directional components using gradient-based optimization to minimize differences between the predicted outputs and training outputs associated with the training inputs. In an embodiment, updating each direction component comprises updating the two low-rank matrices without changing the base vector. In an embodiment, the gradient-based optimization approximates gradients for the two low-rank matrices instead of computing a direction gradient for the direction component. In an embodiment, the gradient-based optimization adjusts the magnitude components in a first direction and adjusts the direction components in a second direction that opposes the first direction.

At step 340, parameter updates are computed based on the updated magnitude components and the updated direction components. In an embodiment, step 340 comprises updating the magnitude components while the direction components remain unchanged to produce modified magnitude components for a portion of the predicted outputs; and updating the modified magnitude components and the direction components for a remaining portion of the predicted outputs to produce the updated magnitude components and the updated direction components. In an embodiment, the updated magnitude component and the updated direction components are used to compute parameter updates for the pre-trained parameters. In an embodiment, the updated pre-trained parameters comprise the fine-tuned parameters.

At step 345, the parameter updates are combined with the pre-trained parameters to produce fine-tuned parameters. In an embodiment, the neural network model applies the fine-tuned parameters to additional training inputs to generate additional predicted outputs; the updated magnitude components and the updated direction components are further updated using gradient-based optimization to minimize differences between the additional predicted outputs and additional training outputs associated with the additional training inputs; and the fine-tuned parameters are updated based on the further updated magnitude components and the further updated direction components.

In an embodiment, at least one of the steps 310, 320, 330, or 340 is performed on a server or in a data center to generate an image, and the image is streamed to a user device. In an embodiment, at least one of the steps 310, 320, 330, or 340 is performed within a cloud computing environment. In an embodiment, at least one of the steps 310, 320, 330, or 340 is performed for training, testing, or certifying the neural network model or an additional neural network model employed in a machine, robot, or autonomous vehicle. In an embodiment, at least one of the steps 310, 320, 330, or 340 is performed on a virtual machine comprising a portion of a graphics processing unit.

FIG. 3B illustrates images generated by a neural network model trained using LoRA and DoRA, in accordance with an embodiment. The neural network model is trained for a text-to-image personalization task using a training dataset of 23 text-image pairs for generating 3D icons. The test prompt input is “a TOK icon of an astronaut riding a horse, in the style of TOK.” 3D icons in the top row 350 are generated using a conventional technique (LoRA). 3D icons in the bottom row 355 are generated using DoRA. The 3D icons generated using DoRA depict a greater variation of poses and detail compared with the 3D icons generated using the conventional technique.

DoRA is a parameter-efficient fine-tuning method that directionally adjusts the pre-trained parameters in a manner which is more closely aligned with adjustments during full fine-tuning compared with conventional techniques. Moreover, by showing a learning behavior similar to FT both empirically and mathematically, suggesting a learning capacity closely resembling FT, DoRA is validated across a wide variety of tasks, from NLP to Vision-Language, and over various backbones, including LLM and large vision-language model (LVLM). The experimental results show that DoRA consistently outperforms LoRA without sacrificing inference efficiency, such as commonsense reasoning, visual instruction tuning, and image/video-text understanding. DoRA can be considered as a costless alternative to LoRA, as its decomposed magnitude and direction components can be merged back into the pre-trained weights after the training, ensuring that there is no extra inference overhead.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

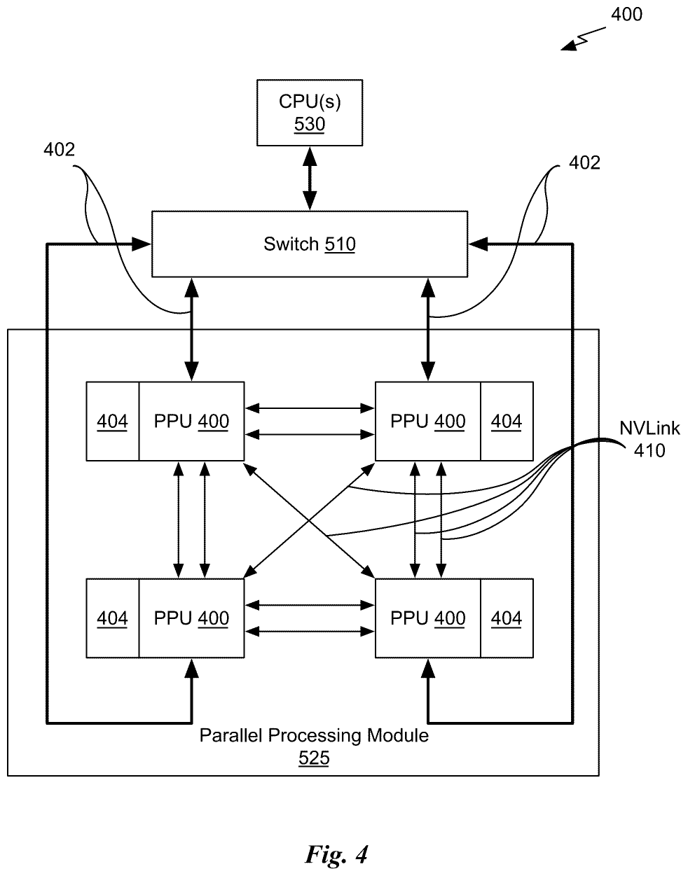

FIG. 4 is a conceptual diagram of a processing system 400 implemented using a PPU, in accordance with an embodiment. The exemplary system 400 may be configured to implement the method 300 shown in FIG. 3A. The processing system 400 includes a CPU 530, switch 510, and multiple PPUs 400, and respective memories 404.

Each parallel processing unit (PPU) 400 may include hundreds or thousands of cores that are capable of handling hundreds or thousands of software threads simultaneously. The PPUs 400 may generate pixel data for output images in response to rendering commands (e.g., rendering commands from the CPU(s) 530 received via a host interface). The PPUs 400 may include graphics memory, such as display memory, for storing pixel data or any other suitable data, such as GPU data. The display memory may be included as part of the memory 404. The PPUs 400 may include two or more GPUs operating in parallel (e.g., via a link). The link may directly connect the GPUs (e.g., using NVLINK 410) or may connect the GPUs through a switch (e.g., using switch 510). When combined together, each PPU 400 may generate pixel data or GPGPU data for different portions of an output or for different outputs (e.g., a first PPU for a first image and a second PPU for a second image). Each PPU 400 may include its own memory 404, or may share memory with other PPUs 400.

The PPUs 400 may each include, and/or be configured to perform functions of, one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

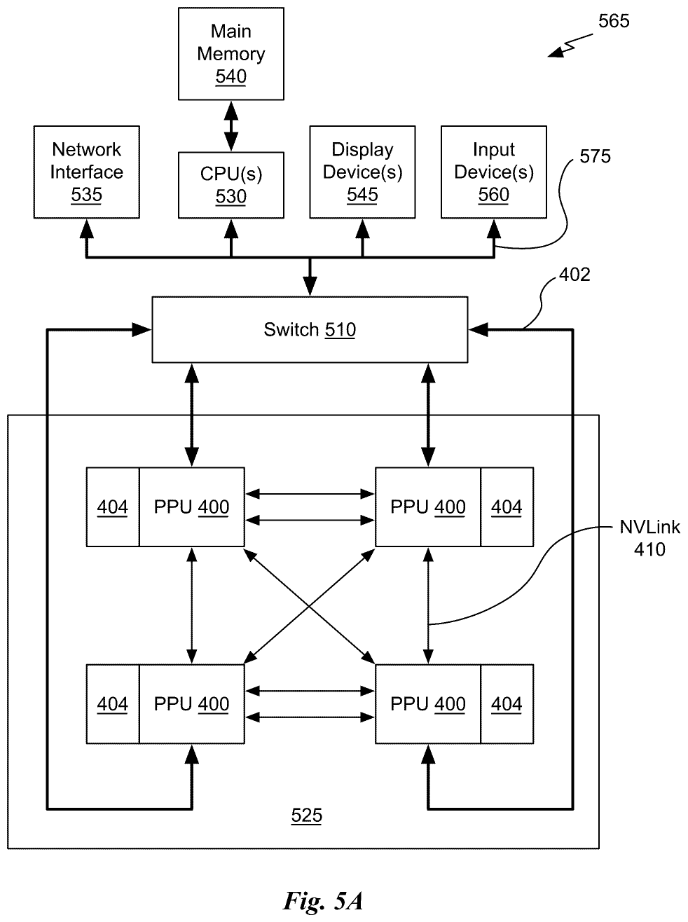

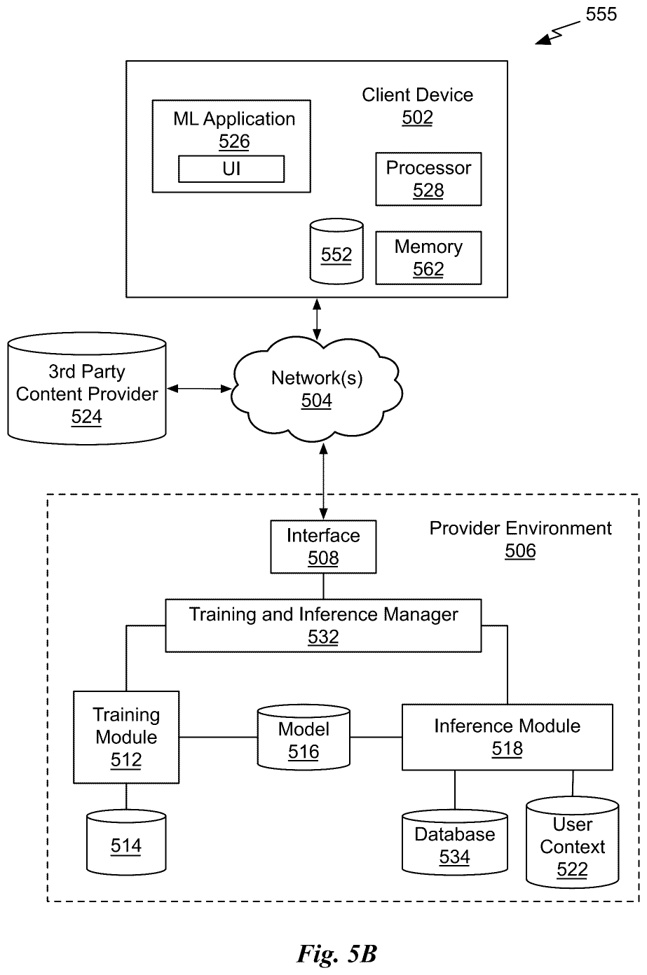

The NVLink 410 provides high-speed communication links between each of the PPUs 400. Although a particular number of NVLink 410 and interconnect 402 connections are illustrated in FIG. 5B, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 5A, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 5A, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

FIG. 5B illustrates an exemplary system 565 in which the various architecture and/or functionality of the various previous embodiments may be implemented. The exemplary system 565 may be configured to implement the method 300 shown in FIG. 3A.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5B are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5B is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5B.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 400 of FIG. 4 and/or exemplary system 565 of FIG. 5A—e.g., each device may include similar components, features, and/or functionality of the processing system 400 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 400 of FIG. 4 and/or exemplary system 565 of FIG. 5A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5B illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506.

In at least one embodiment, supervised and/or unsupervised training can be performed by the client device 502 and/or the provider environment 506. In at least one embodiment, a set of training data 514 (e.g., classified or labeled data) is provided as input to function as training data. In an embodiment, the set of training data may be used in a generative adversarial training configuration to train a generator neural network.

In at least one embodiment, training data can include images of at least one human subject, avatar, or character for which a neural network is to be trained. In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

a graphics processing pipeline may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the PPU 400. The API provides an abstraction for a programmer that lets a programmer utilize specialized graphics hardware, such as the PPU 400, to generate the graphical data without requiring the programmer to utilize the specific instruction set for the PPU 400. The application may include an API call that is routed to the device driver for the PPU 400. The device driver interprets the API call and performs various operations to respond to the API call. In some instances, the device driver may perform operations by executing instructions on the CPU. In other instances, the device driver may perform operations, at least in part, by launching operations on the PPU 400 utilizing an input/output interface between the CPU and the PPU 400. In an embodiment, the device driver is configured to implement the graphics processing pipeline utilizing the hardware of the PPU 400.

Various programs may be executed within the PPU 400 in order to implement the various stages of the graphics processing pipeline. For example, the device driver may launch a kernel on the PPU 400 to perform a vertex shading stage on one processing unit (or multiple processing units). The device driver (or the initial kernel executed by the PPU 400) may also launch other kernels on the PPU 400 to perform other stages of the graphics processing pipeline, such as a geometry shading stage and a fragment shading stage. In addition, some of the stages of the graphics processing pipeline may be implemented on fixed unit hardware such as a rasterizer or a data assembler implemented within the PPU 400. It will be appreciated that results from one kernel may be processed by one or more intervening fixed function hardware units before being processed by a subsequent kernel on a processing unit. a

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

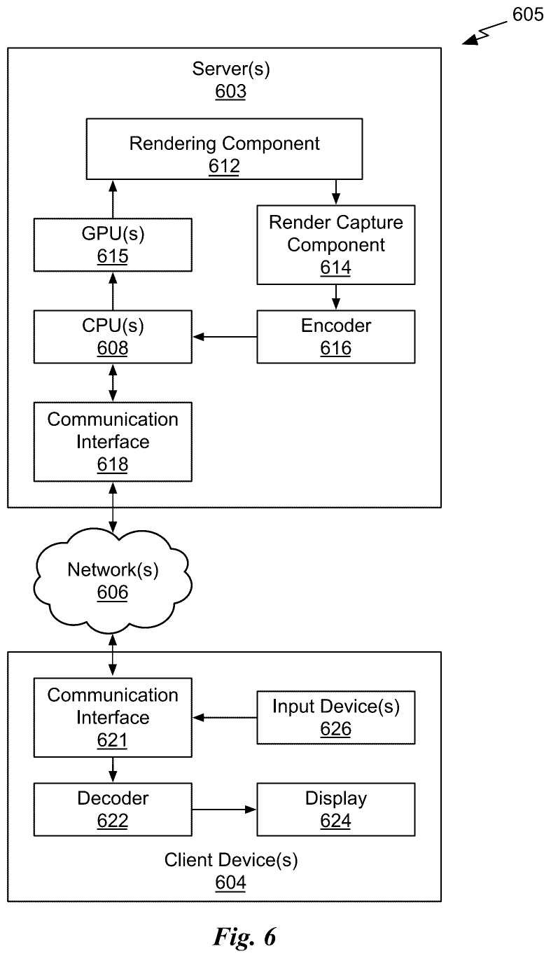

FIG. 6 is an example system diagram for a streaming system 605, in accordance with some embodiments of the present disclosure. FIG. 6 includes server(s) 603 (which may include similar components, features, and/or functionality to the example processing system 400 of FIG. 4 and/or exemplary system 565 of FIG. 5A), client device(s) 604 (which may include similar components, features, and/or functionality to the example processing system 400 of FIG. 4 and/or exemplary system 565 of FIG. 5A), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units-such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A computer-implemented method for fine-tuning parameters of a neural network model, comprising:
decomposing pre-trained parameters for the neural network model into magnitude components and direction components;
applying, by the neural network model, the pre-trained parameters to training inputs to generate predicted outputs;
updating the magnitude components and direction components using gradient-based optimization to minimize differences between the predicted outputs and training outputs associated with the training inputs;
computing parameter updates based on the updated magnitude components and the updated direction components; and
combining the parameter updates with the pre-trained parameters to produce fine-tuned parameters.

2. The computer-implemented method of claim 1, further comprising:
applying, by the neural network model, the fine-tuned parameters to additional training inputs to generate additional predicted outputs;
further updating the updated magnitude components and the updated direction components using gradient-based optimization to minimize differences between the additional predicted outputs and additional training outputs associated with the additional training inputs; and
updating the fine-tuned parameters based on the further updated magnitude components and the further updated direction components.

3. The computer-implemented method of claim 1, wherein the magnitude components each comprise a scalar value defining a length.

4. The computer-implemented method of claim 1, wherein the direction components each comprise a base vector and two low-rank matrices.

5. The computer-implemented method of claim 4, wherein updating each direction component comprises updating the two low-rank matrices without changing the base vector.

6. The computer-implemented method of claim 4, wherein the gradient-based optimization approximates gradients for the two low-rank matrices instead of computing a direction gradient for the direction component.

7. The computer-implemented method of claim 1, wherein the gradient-based optimization adjusts the magnitude components in a first direction and adjusts the direction components in a second direction that opposes the first direction.

8. The computer-implemented method of claim 1, wherein the neural network model performs a task in a domain including at least one of language, image, and video.

9. The computer-implemented method of claim 1, wherein the updating comprises:
updating the magnitude components while the direction components remain unchanged to produce modified magnitude components for a portion of the predicted outputs; and
updating the modified magnitude components and the direction components for a remaining portion of the predicted outputs to produce the updated magnitude components and the updated direction components.

10. The computer-implemented method of claim 1, wherein at least one of the steps of decomposing, applying, updating, computing, or combining is performed on a server or in a data center to generate an image, and the image is streamed to a user device.

11. The computer-implemented method of claim 1, wherein at least one of the steps of decomposing, applying, updating, computing, or combining is performed within a cloud computing environment.

12. The computer-implemented method of claim 1, wherein at least one of the steps of decomposing, applying, updating, computing, or combining is performed for training, testing, or certifying the neural network model or an additional neural network model employed in a machine, robot, or autonomous vehicle.

13. The computer-implemented method of claim 1, wherein at least one of the steps of decomposing, applying, updating, computing, or combining is performed on a virtual machine comprising a portion of a graphics processing unit.

14. A system, comprising:
a memory that stores pre-trained parameters for a neural network model; and
a processor that is connected to the memory, wherein the processor is configured to fine-tune parameters of the neural network model by:
decomposing the pre-trained parameters into magnitude components and direction components;
applying, by the neural network model, the pre-trained parameters to training inputs to generate predicted outputs;
updating the magnitude components and direction components using gradient-based optimization to minimize differences between the predicted outputs and training outputs associated with the training inputs;
computing parameter updates based on the updated magnitude components and the updated direction components; and
combining the parameter updates with the pre-trained parameters to produce fine-tuned parameters.

15. The system of claim 14, wherein the direction components each comprise a base vector and two low-rank matrices.

16. The system of claim 15, wherein updating each direction component comprises updating the two low-rank matrices without changing the base vector.

17. The system of claim 15, wherein the gradient-based optimization approximates gradients for the two low-rank matrices instead of computing a direction gradient for the direction component.

18. The system of claim 14, wherein the magnitude components each comprise a scalar value defining a length.

19. A non-transitory computer-readable media storing computer instructions for fine-tuning parameters of a neural network model that, when executed by one or more processors, cause the one or more processors to perform the steps of:
decomposing pre-trained parameters for the neural network model into magnitude components and direction components;
applying, by the neural network model, the pre-trained parameters to training inputs to generate predicted outputs;
updating the magnitude components and direction components using gradient-based optimization to minimize differences between the predicted outputs and training outputs associated with the training inputs;
computing parameter updates based on the updated magnitude components and the updated direction components; and
combining the parameter updates with the pre-trained parameters to produce fine-tuned parameters.

20. The non-transitory computer-readable media of claim 19, wherein the direction components each comprise a base vector and two low-rank matrices.
